(19) United States
(12) Patent Application Publication
(10) Pub. No.: US 2016/0192022 A1
(43) Pub. Date: Jun. 30, 2016

(54) ELECTRONIC DEVICE, METHOD, AND STORAGE MEDIUM

(71) Applicants: KABUSHIKI KAISHA TOSHIBA, Tokyo (JP); Toshiba Lifestyle Products & Services Corporation, Tokyo (JP)

(72) Inventor: Shunji Ui, Ome Tokyo (JP)

(21) Appl. No.: 15/064,251

(22) Filed: Mar. 8, 2016

Related U.S. Application Data
(63) Continuation of application No. PCT/JP2013/074695, filed on Sep. 12, 2013.

(51) Int. Cl. H04N 21/482; H04N 5/445; H04N 21/472; H04N 21/61; H04N 5/76; H04N 21/433

(52) U.S. Cl. CPC H04N 21/4828; H04N 5/7605; H04N 21/4334; H04N 21/47214; H04N 21/6125; H04N 5/44543

(57) ABSTRACT

According to one embodiment, an electronic device includes a display device, a setting device, and a hardware processor. The display device displays content. The setting device sets a search condition. The hardware processor determines a type of content according to a state of the display device and searches content based on the search condition and the type of content.

### CROSS-REFERENCE TO RELATED APPLICATIONS

This application is a Continuation Application of PCT Application No. PCT/JP2013/074695, filed Sep. 12, 2013, the entire contents of which are incorporated herein by reference.

### FIELD

Embodiments described herein relate generally to an electronic device, a method, and a storage medium, each for searching content.

### BACKGROUND

A television receiver which is capable of recording programs, searching the recorded programs, and reproducing a program which one wants to enjoy is hitherto developed. Such a television receiver has an Internet connectivity function in many cases. A system for finding desired content, including recorded programs, network content, or scheduled broadcast programs (hereafter, a “program” is also called “content”), has been developed.

However, the conventional search system does not have a function of allowing a user to specify a type of content (scheduled broadcast programs, recorded programs, network content) at the time of search. Therefore, search results may often include content of a type that does not meet a user's intention.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary block diagram illustrating a structure of the whole of a video system in a first embodiment.

FIG. 2 is an exemplary flowchart illustrating an operation of the first embodiment.

FIG. 3 is a view illustrating an exemplary GUI presentation displayed on a display device of a search condition input device in the first embodiment.

FIGS. 4A and 4B illustrate an exemplary search operation of the first embodiment.

FIG. 5 is an exemplary flowchart illustrating an operation of a second embodiment.

FIG. 6 is an exemplary flowchart illustrating an operation of a third embodiment.

FIG. 7 is a view illustrating an exemplary GUI presentation displayed on a display device of a search condition input device in a fourth embodiment.

FIG. 8 is an exemplary flowchart illustrating an operation of the fourth embodiment.

FIGS. 9A, 9B, and 9C illustrate an exemplary search operation of the fourth embodiment.

FIG. 10 is an exemplary block diagram illustrating a structure of the whole of a video system in a fifth embodiment.

### DETAILED DESCRIPTION

Various embodiments will be described hereinafter with reference to the accompanying drawings. In general, according to one embodiment, an electronic device includes a display device, a setting device, and a hardware processor. The display device displays content. The setting device sets a search condition. The hardware processor determines a type of content according to a state of the display device and searches content based on the search condition and the type of content.

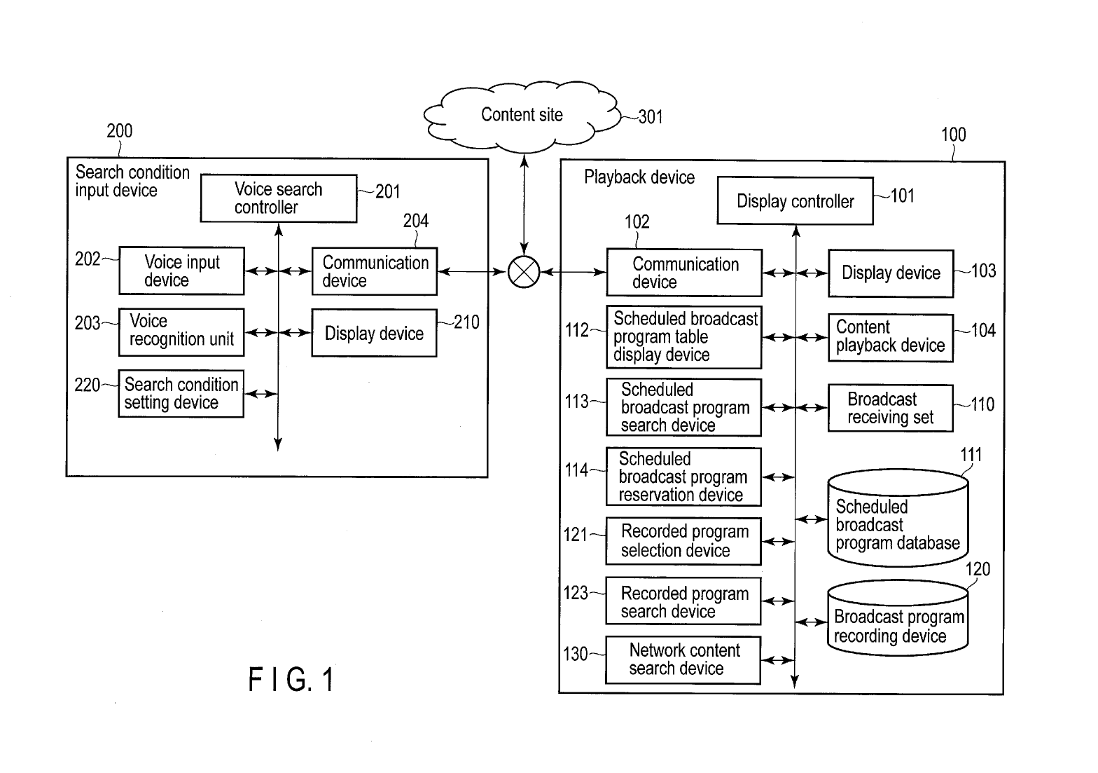

FIG. 1 is a block diagram of the whole of a video system in the first embodiment. The system includes a playback device 100, a search condition input device 200, and a content site 301. The video system can manage various pieces of content, including broadcast programs, scheduled broadcast programs, recorded programs obtained by recording selected broadcasts, and network content. In the embodiment, the system is not required to manage all types of content, but is required to manage only some types of content.

The playback device 100 includes, for example, a digital television receiver and a set-top box, each having a recording function, and a recorder. The search condition input device 200 includes, for example, a remote controller, a smart phone, a tablet computer, etc. The playback device 100, the search condition input device 200, and the content site 301 are connected to one another via the Internet. It should be noted here that the playback device 100 and the content site 301 may be connected via the Internet, but the playback device 100 and the search condition input device 200 need not be connected via the Internet. It is possible that they may be connected by short-range wireless communication, such as Bluetooth (registered trademark) instead of the Internet.

The structure of the playback device 100 will be explained. The playback device 100 includes a display controller 101, a communication device 102, a display device 103, a content playback device 104, a broadcast receiving set 110, a scheduled broadcast program database 111, a scheduled broadcast program table display device 112, a scheduled broadcast program search device 113, a scheduled broadcast program reservation device 114, a broadcast program recording device 120, a recorded program selection device 121, a recorded program search device 123, and a network content search device 130, all connected to a system bus.

The broadcast receiving set 110 receives a digital broadcasting stream, and sends the digital broadcasting stream to the content playback device 104. The content playback device 104 decodes the digital broadcasting stream to obtain a video, and displays the video on the display device 103. It also extracts scheduled broadcast programs data (EPG data), which is superimposed on the digital broadcasting stream, and stores the extracted data in the scheduled broadcast program database 111.

The scheduled broadcast program table display device 112 causes the display device 103 to display in a list form the scheduled broadcast programs data. This function may be implemented by an application program. The user selects a program from the scheduled broadcast programs data list displayed on the screen of the display device 103 for viewing the selected program on time or reserving the selected program for recording or later viewing.

The scheduled broadcast program search device 113 searches scheduled broadcast program data in the scheduled broadcast program database 111 based on the specified search condition, and causes the display device 103 to display in a list form all scheduled broadcast programs that satisfy the search condition. This function may be implemented by an application program. The user selects a program from the scheduled broadcast programs list displayed on the screen of the display device 103 for viewing the selected program on time or reserving the selected program for recording or later viewing.

The scheduled broadcast program reservation device 114 reserves, for viewing or recording, the scheduled broadcast program which the user selected using the scheduled broadcast program table display device 112 or the scheduled broadcast program which the user selected using the scheduled broadcast program search device 113. This function may be implemented by an application program. The reservation information is recorded on the scheduled broadcast program database 111.

The digital broadcasting stream received with the broadcast receiving set 110 is recorded by the broadcast program recording device 120 according to recording reservation of the scheduled broadcast program reservation device 114. The recorded program selection device 121 causes the display device 103 to display a content list currently stored in the broadcast program recording device 120. This function may be implemented by an application program. The user selects a program from the content list, and enjoys viewing the selected program.

The network content search device 130 allows the user to browse network content. This function may be implemented by a browser application program. The network content search device 130 causes the display device 103 to display the network content based on a specified URL and a specified search condition.

The display controller 101 controls execution of a function or an application program, or reproduction of content. It also manages the display state of the display device 103, namely, it manages which function or application program the display device 103 executes and which content the display device 103 displays.

The communication device 102 performs data communication with an external device, accepts a search execution request from the external device, and allows the search execution request to be input to the display controller 101. A search condition including the following items is given to a search execution request.
Type of content (scheduled broadcast programs, recorded programs, network content search URL's)
Keyword
Genres (news, movies, sports, etc.)
Date
Broadcast type (terrestrial digital broadcasting/BS/CS)
Broadcasting station

The display controller 101 operates the scheduled broadcast program search device 113, the recorded program search device 123, or the network content search device 130 in accordance with the type of content in the search condition. Furthermore, the type of content may not be limited to the above but may include on-air programs, photographs or moving images stored in an SD card, moving images stored in an NAS server, etc. In such a case, the display controller 101 operates suitable devices for their respective reproduction (some of the devices are not included in what is illustrated in FIG. 1).

The communication device 102 accepts a display state acquisition request from an external device, acquires a display state from the display controller 101, and notifies it to the external device which is a requesting source.

Now, the search condition input device 200 will be explained. The search condition input device 200 may include a keyboard, a microphone using speech recognition technology, etc. Here, an input by a microphone will be explained as an example. The search condition input device 200 includes a voice search controller 201, a voice input device (microphone) 202, a voice recognition unit 203, a communication device 204, a display device 210, and a search condition setting device 220, all being connected to a system bus.

The display device 210 includes a touch panel which performs a GUI presentation and responds to button operation. The voice search controller 201 controls the GUI presentation of the display device 210. An event produced by button operation is notified to the voice search controller 201. It should be noted that, since the GUI presentation and button operation in the present embodiment are used for allowing the user to instruct the system to start a voice input, a hardware button without any display may be substituted for them.

The voice data input by the voice input device 201 is changed into character data by the voice recognition unit 203, and is input into the search condition setting device 220. The search condition setting device 220 analyzes the syntax of the character data obtained by the voice recognition unit 203, and extracts words. It determines to which item of a search condition each of the words corresponds, and sets a search condition.

The voice search controller 201 controls the voice input device 202, the voice recognition unit 203, the display device 210, and the search condition setting device 220, and sends a search execution request through the communication device 204 to the playback device 100.

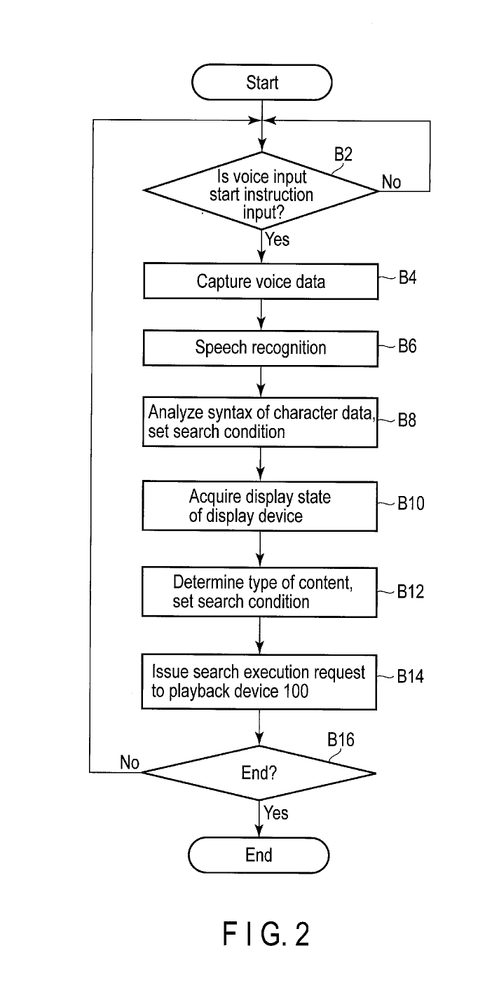

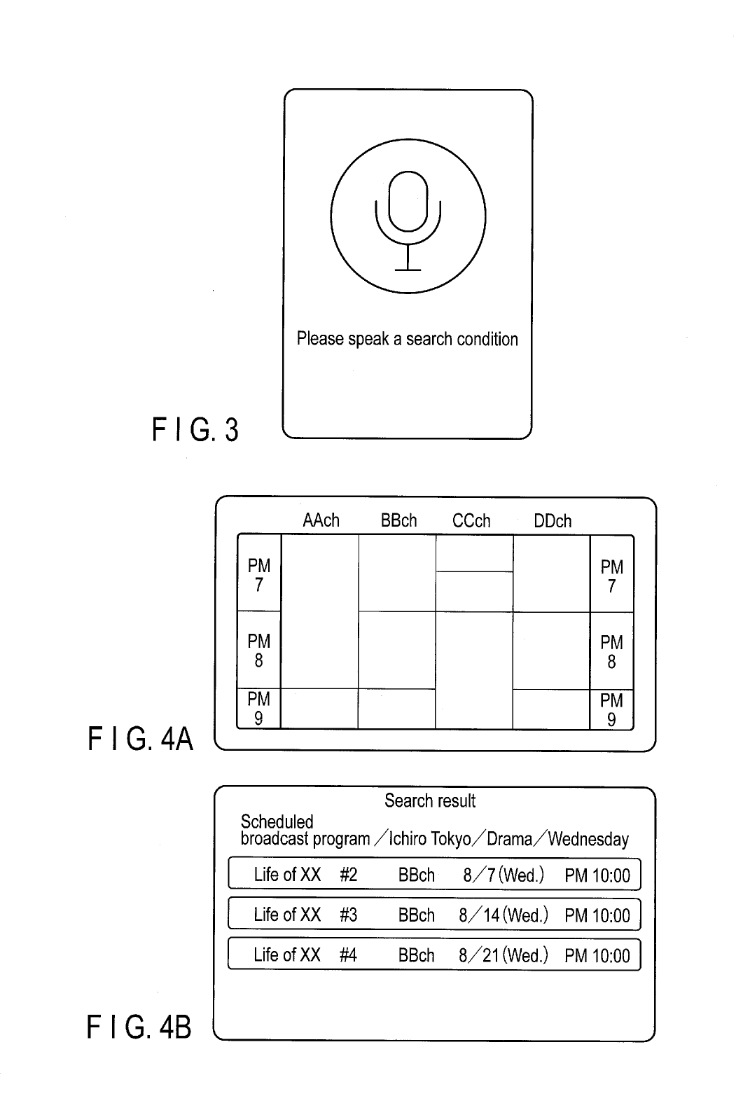

FIG. 2 is a flowchart which illustrates operation of the voice search controller 201. In block B2, the display device 210 displays a GUI presentation indicative of an utterance start button, and the voice search controller 201 waits for the user to indicate a start of a voice input event. FIG. 3 illustrates an exemplary utterance start button.

Upon detecting that a voice input start instruction has been input or that the user has pressed the button, the voice input device 202 is instructed to capture voice data in block B4. The discontinuance of the input of voice data for a prescribed time will be regarded as termination of utterance, and the captured voice data will be input into the voice recognition unit 203. The input voice data is changed into character data by the voice recognition unit 203 in block B6 (speech recognition).

In block B8, the syntax of the character data obtained in block B6 is analyzed by the search condition setting device 220. Words are extracted. It is determined to which item of a search condition each of the words extracted corresponds. Then, a search condition is set. For example, the following items of a search condition are set.
Keyword
Genre
Date
Broadcast type
Broadcasting station

For example, when the syntax analysis reveals that a word indicates a day of the week, the word is recognized as a date item. Similarly, when the syntax analysis reveals that a word indicates any one of a drama, a movie, a sport, or the like, the word is recognized as a genre item. A word that does not belong to any item is recognized as a keyword.

In block B10, an acquisition request of a display state of the display device 103 is issued through the communication device 204 to the playback device 100, and a display state is acquired. In block B12, a type of content which is most suitable for the display state of the display device 103 acquired in block B10 will be set as the “type of content” in the search condition. The voice search controller 201 has a table for determining an optimal target for search. The table defines the most suitable target of search for the display state of the display device 103, as illustrated in, for example, the following Table 1. The table may be determined based on various experiences, various experiments, and various investigations.

TABLE 1

| State of display device 103 | Type of content |
|---|---|
| Display of broadcast | Recorded programs |
| program in progress | |
| Scheduled broadcast | Scheduled broadcast |
| program table application | programs |
| in execution | |
| Scheduled broadcast | Scheduled broadcast |
| program search | programs |
| application in execution | |
| Scheduled broadcast | Scheduled broadcast |
| program reservation | programs |
| application in execution | |
| Reproduction of recorded | Recorded programs |
| program in progress | |
| Recorded program | Recorded programs |
| selection application in | |
| execution | |
| Recorded program search | Recorded programs |
| application in execution | |
| Reproduction of network | Network content |
| content in progress | |
| Network content search | Network content |
| application in progress | |

In block B14, a search execution request, to which the set search condition is given, is sent through the communication device 204 to the playback device 100.

It is determined in block B16 whether the voice search is terminated or not. When it is not yet terminated, the system successively repeats all the steps from block B2.

FIGS. 4A and 4B illustrate, as an exemplary operation of the voice search controller 201, an exemplary search which will be executed when the voice search controller 201 generates as a search condition “a drama of Tokyo Ichiro on Wednesday” while the display device 103 is executing a scheduled broadcast program table application (FIG. 4A). In such a case, an item “scheduled broadcast program” is selected in block B10 from Table 1 as a “target of search” suitable for the “scheduled broadcast program table application in progress”. A search execution request is issued as follows.
Type of content: “scheduled broadcast programs”
Keyword: “Tokyo Ichiro”
Genre: “drama”
Date: “Wednesday”
Broadcast type: not specified
Broadcasting station: not specified

The playback device 100 searches the “scheduled broadcast programs” for a drama which will be broadcast on Wednesday and includes “Tokyo Ichiro” as a keyword. The playback device 100 then causes the display device 103 to display a search result (FIG. 4B). Even if the search result includes two or more programs, they have been narrowed down to some extent. Therefore, it is easy for the user to choose one program among them.

As explained above, in the first embodiment, a type of content can be specified when executing a search. Therefore, a search result will be confined to those things that are suitable in type. Namely, those things that do not meet a user's intention will surely be excluded from the search result. Moreover, the type of content will be set automatically according to a display state of the display device 103 of the playback device 100, namely, which function or application the display device 103 is executing or which content the display device 103 is displaying. Accordingly, even if a user does not specify a type of content, what should be searched for will be automatically restricted to content of an optimal type. Furthermore, since a search condition can be vocally input, a setup of a search condition will be easy.

Hereafter, other embodiments will be described. In the explanation of the other embodiments, the same sections as those of the first embodiment are attached with the same reference numbers, and the detailed explanation of the sections will be omitted.

### Second Embodiment

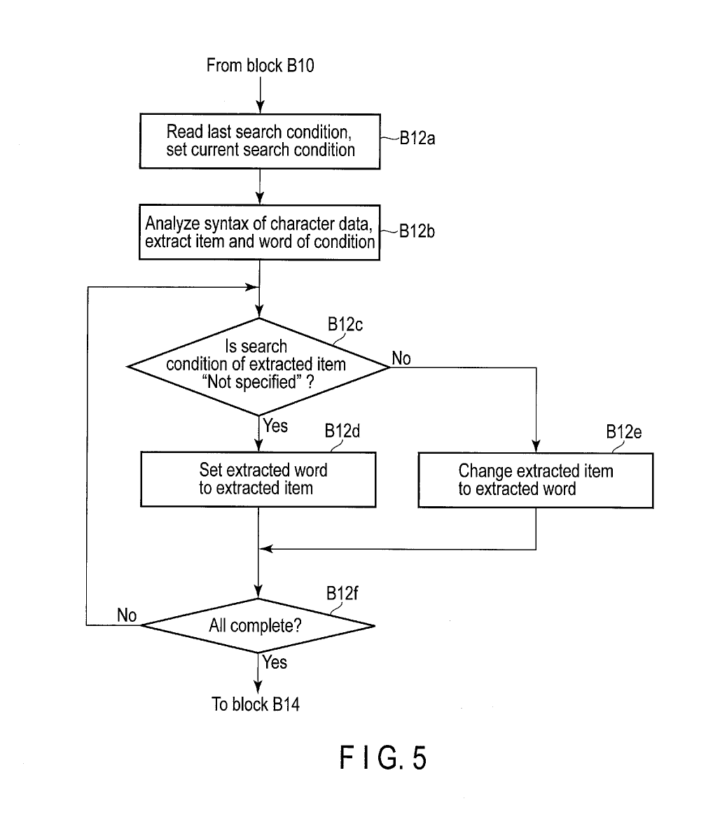

Since the block diagram of a second embodiment is the same as the block diagram of the first embodiment illustrated in FIG. 1, the illustration of the block diagram will be omitted. However, the second embodiment is different from the first embodiment in that the search condition setting device 220 stores the last search condition. In connection with this, the flowchart concerning the voice search controller 201 of the second embodiment is changed as illustrated in FIG. 5 in respect of the block B12 of FIG. 2.

In block B12a, the last search condition is read out and is set as a current search condition. If it is a first-time search, each item of a search condition will be cleared to be “not specified.”

In block B12b, syntax analysis of the input character data is performed, words are extracted, and it is determined of which item of a search condition each extracted word corresponds.

It is determined in block B12c whether the item of a search condition obtained in block B12b is labeled as “not specified”. When it is determined to be yes, the word having been obtained in block B12b is newly set to the item of this search condition in block B12d. When the determination result of block B12c indicates no, i.e., when a certain word is already set to the item of the search condition, in block B12e, the item of the search condition will be changed into the word obtained in block B12b.

It is determined in block B12f whether the process of setting all the extracted words to the suitably corresponding respective items has been completed. In the case of no, a process of setting the following item will be successively performed in block B12c.

Accordingly, the voice input of the search condition can be carried out for several times, and the search condition can be changed. If an item of a search condition which is not specified in the last search condition is newly input when a new search condition is set on and after the second time, the newly input item will be added to the existing search condition. Thus, a new search condition for what is called a narrowing down search may be set (block B12d). Moreover, when a new word is input to an item previously specified as a constituent of a search condition, a fresh search condition which is partially changed in item will be newly set (block B12e).

Exemplary operation of the second embodiment will be explained. For example, when the speech sound “a drama played by Tokyo Ichiro” is input for the first time, the voice search controller 201 will set the following as a search condition.
Type of content: “scheduled broadcast programs”
Keyword: “Tokyo Ichiro”
Genre: “drama”
Date: not specified
Broadcast type: not specified
Broadcasting station: not specified

The playback device 100 performs a search based on the above condition, and the display device 103 displays a search result. In order to change the existing search condition, the speech sound “a movie played by Tokyo Hanako” is input for a second time. The search condition setting device 220 determines that an item “keyword” and an item “genre” are input. Some terms were set to the two items in the last search condition (“Tokyo Ichiro” was set to the item “keyword” and “drama” was set to the item “genre”). The items of the search condition will be changed to new respective terms having been input this time in block B12e (the item “keyword” is changed from “Tokyo Ichiro” to “Tokyo Hanako,” and the item “genre” is changed from “drama” to “movie”). The following will be set as a new search condition.
Type of content: “scheduled broadcast programs”
Keyword: “Tokyo Hanako” (changed)
Genre: “movie” (changed)
Date: not specified
Broadcast type: not specified
Broadcasting station: not specified

When the speech sound “a recorded program” is input instead of the speech sound “a movie played by Tokyo Hanako” at the time of the second voice input, the search condition setting device 220 will determine that the item “type of content” has been input. Since a phrase “scheduled broadcast programs” is set to the item of the last search condition, the item will be changed from “scheduled broadcast programs” to “recorded programs” in block B12e. The following will be established as a new search condition.
Type of content: “recorded programs”
Keyword: “Tokyo Ichiro”
Genre: “drama”
Date: not specified
Broadcast type: not specified
Broadcasting station: not specified

When the speech sound “Wednesday” is input instead of the speech sound “a movie played by Tokyo Hanako” at the time of the second voice input, the search condition setting device 220 will determine that the input word belongs to the item “date.” The item concerned is “not specified” in the last search condition. Accordingly, the word “Wednesday” having been input this time is newly set to the search condition item concerned in block B12d. The following new items will be set as a new search condition.
Type of content: “scheduled broadcast programs”
Keyword: “Tokyo Ichiro”
Genre: “drama”
Date: “Wednesday”
Broadcast type: not specified
Broadcasting station: not specified

When the speech sound “a program recorded on Wednesday” is input instead of the speech sound “a movie played by Tokyo Hanako” at the time of the second voice input, the search condition setting device 220 will determine that two items, “type of content” and “date”, are input. Since the item “type of content” is set as “scheduled broadcast programs” in the last search condition, the item “type of content” will be changed from “scheduled broadcast programs” to “recorded programs” in block B12e. Since the item “date” is “not specified” in the last search condition, the item “date” is newly established as “Wednesday” in block B12d. In this way, the existing search condition is subjected to some modification and addition, and the following new search condition will be established.
Type of content: “recorded programs”
Keyword: “Tokyo Ichiro”
Genre: “drama”
Date: “Wednesday”
Broadcast type: not specified
Broadcasting station: not specified

As explained above, in the second embodiment, a search condition having been once set in accordance with a first voice input can be partly changed in accordance with a voice input for a second time and afterward. Therefore, it is not necessary to restate every item of the search condition. What is necessary is merely to utter some words concerning an item or some items which the user wants to change. Then, a narrowed down search, in which the existing search condition is further narrowed down, or a modified search, in which the existing search condition is partly changed, can be easily set. Furthermore, a modified narrowed down search, which is the combination of the above-mentioned two searches, can also be easily set.

When a search condition is vocally set in the conventional system, the whole items of the search condition must be uttered even in a case where the existing search condition should be partly changed. For example, when the existing search condition “search the recorded programs for golf” should be changed to a new search condition “search broadcast programs for golf”, the user must take the trouble to say “search broadcast programs for golf.” Moreover, in order to execute a narrowed down search by adding a further requirement to a search result displayed after a normal search has been executed under the search condition “search broadcast programs for golf”, the user must take the trouble to give the whole utterance which includes all the items of the narrowed down search condition. The user therefore must say “search Wednesday broadcast programs for golf,” for instance. Furthermore, when the items are insufficient, or when the items are wrongly recognized, the search condition has to be wholly uttered again from the outset.

In contrast, what is necessary in the second embodiment is to utter only those items in the existing search condition that should be changed.

### Third Embodiment

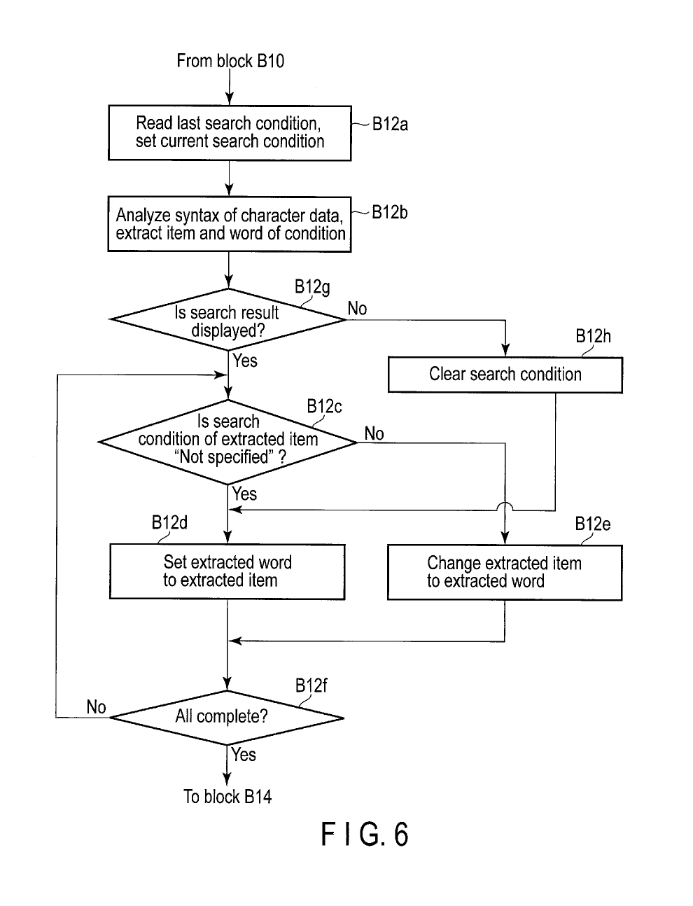

A third embodiment is a modification of the second embodiment. In the third embodiment, the timing of executing the above-explained process of the second embodiment is restricted. That is, change of the search condition caused by the voice input given for the second time and afterward will be permitted only while a result of the last search is being displayed. In connection with this modification, two blocks B12g and B12h are added to the flowchart of FIG. 5, resulting in the flowchart of the voice search controller 201 of the third embodiment, which is illustrated in FIG. 6.

Block B12b is followed by block B12g. The search condition setting device 220 determines in block B12g whether the display device 103 of the playback device 100 displays the last search result. If a search result is being displayed, it will advance to block B12c, and the process of the second embodiment will be performed. When the search result is not being displayed, it will advance to block B12h, and all the items of the search condition will be cleared. This is because the voice input given for this time is not considered as a voice input that is given for the second time and afterwards in order to change the existing search condition but is considered as a voice input given for the first time. After the existing search condition has been cleared, all the search items newly input this time will establish a new search condition in block B12d.

It should be noted that the determination in block B12g is made based on the result of which application among the scheduled broadcast program search application, the recorded program search application, and the network content search application the display device 103 of the playback device 100 displays in accordance with a type of content having been set at the time of setting up the last search condition.

This makes it possible to allow a re-search or a narrowed down search to be performed under the condition of a partial replacement of a search condition only when the result of the last search is displayed on the screen and to perform a new search when any other state is displayed on the screen.

### Fourth Embodiment

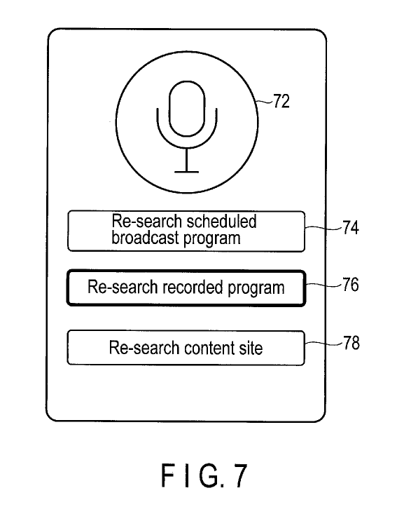

A fourth embodiment makes a re-search easy. FIG. 7 illustrates a GUI presentation which is displayed by the display device 210 of the search condition input device 200 in the fourth embodiment for urging a user to start making an utterance. FIG. 7 not only illustrates a “voice input start” button 72 which urges a user to start a voice input in the same way as that illustrated in FIG. 3, but also illustrates a “re-search scheduled broadcast program” button 74, a “re-search recorded program” button 76, and a “re-search content site” button 78. One of these three re-search buttons is pressed. Then, the user event indicated by the pressed button is notified to the voice search controller 201 similarly to the voice input start event. It should be noted that, when a search is performed for the first time, these re-search buttons are made to be invalid or not to be displayed.

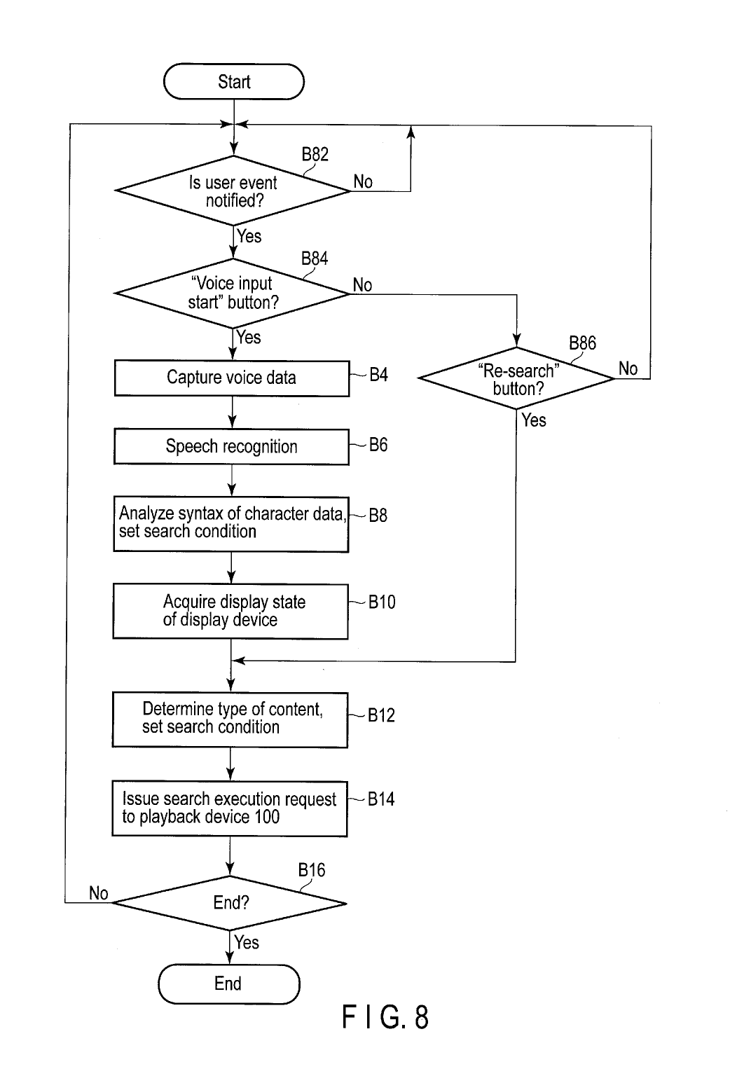

FIG. 8 is a flowchart which illustrates operation of the voice search controller 201 of the fourth embodiment. This flowchart is obtained by adding blocks B82, B84, and B86 to the flowchart of the first embodiment illustrated in FIG. 2.

In block B82, it is determined whether the user event has been notified from the display 210 of the search condition input device 200. When there is a user event notification, it is determined in block B84 whether or not the “voice input start” button 72 has been pressed.

When the “voice input start” button 72 is pressed, the process after block B4 will be performed similarly to the first embodiment.

When any one of the “re-search scheduled broadcast program” button 74, the “re-search recorded program” button 76, and the “re-search content site” button 78 is pressed instead of the “voice input start” button 72, the process advances to block B12. Namely, when any one of the re-search buttons is pressed, voice data capture (block 34), voice recognition (block B6), character data syntax analysis and search condition setup (block B8), and display state acquisition request (block B10) are all skipped, and the type of content is determined (changed) according to the type of the pressed re-search button in block B12. In the case of a re-search, an item “type of content” is only changed, but the rest of the items are not changed and the last setup is used as-is for the remaining items.

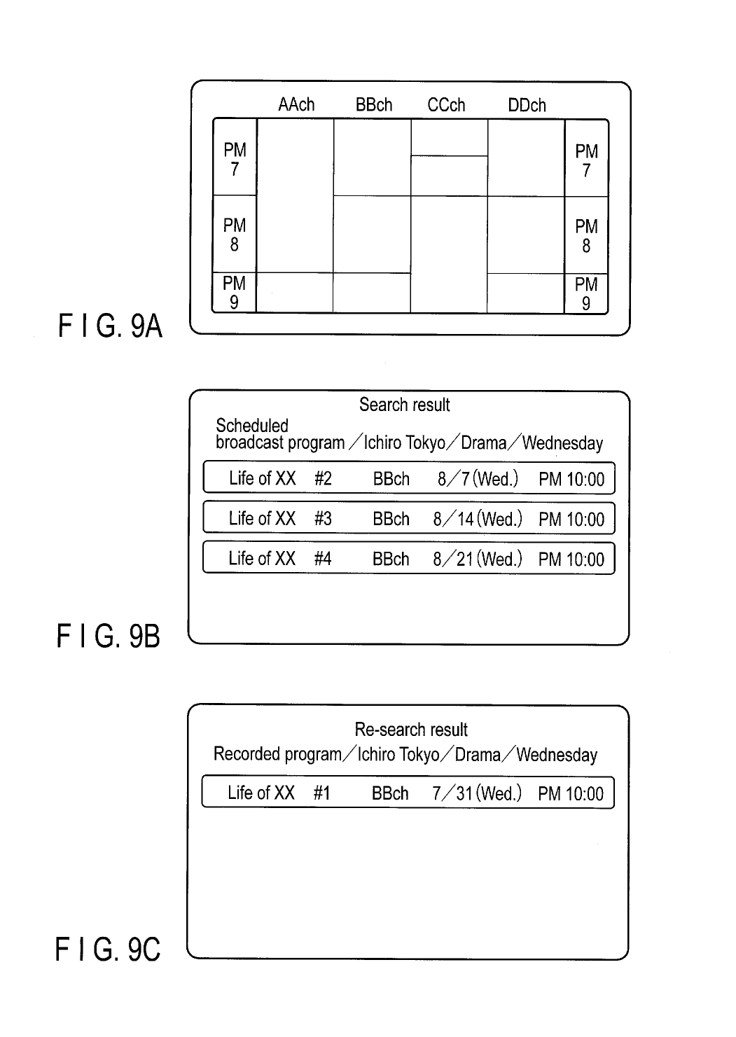

FIGS. 9A, 9B, and 9C illustrate an exemplary operation of the fourth embodiment. FIGS. 9A and 9B include views which are the same as the views of FIGS. 4A and 4B. What is illustrated is an exemplary search which will be executed when “a drama of Tokyo Ichiro on Wednesday” is generated while the display device 103 is executing a scheduled broadcast program table application (FIG. 9A). In such a case, “scheduled broadcast program” is selected from Table 1 as a “target of search” suitable for the “scheduled broadcast program table application in progress.” A search execution request is issued on the following condition.
Type of content: “scheduled broadcast program”
Keyword: “Tokyo Ichiro”
Genre: “drama”
Date: “Wednesday”
Broadcast type: not specified
Broadcasting station: not specified

The playback device 100 searches the “scheduled broadcast programs” for a drama which will be broadcast on Wednesday and includes “Tokyo Ichiro” as a keyword. The playback device 100 then causes the display device 103 to display a search result (FIG. 4B). The search result naturally indicates scheduled broadcast programs alone. The user should merely press one of the three re-search buttons illustrated in the GUI presentation of FIG. 7 to perform not a search of scheduled broadcast programs but search of another type of content. For example, when the “re-search recorded program” button 76 is pressed, the type of content will be changed from a “scheduled broadcast program” to a “recorded program”, but the other search condition items are still in the state of the last search condition. That is, the search condition of a re-search may be set as follows.
Type of content: “recorded program”
Keyword: “Tokyo Ichiro”
Genre: “drama”
Date: “Wednesday”
Broadcast type: not specified
Broadcasting station: not specified

Accordingly, a re-search result as illustrated in FIG. 9C will be displayed. In this way, a target for a new search will be changed simply and surely without requiring once more uttering the type of content for the new search to establish a new search condition.

### Fifth Embodiment

A fifth embodiment concerns a modification of the system configuration. The first embodiment illustrated in FIG. 1 has been explained as having a structure in which the voice recognition unit 203 and the search condition setting device 220 are arranged at a side where the search condition input device 200 is. However, it is possible to arrange these at a side where the playback device 100 is. Furthermore, it is possible to implement them as site of the Internet.

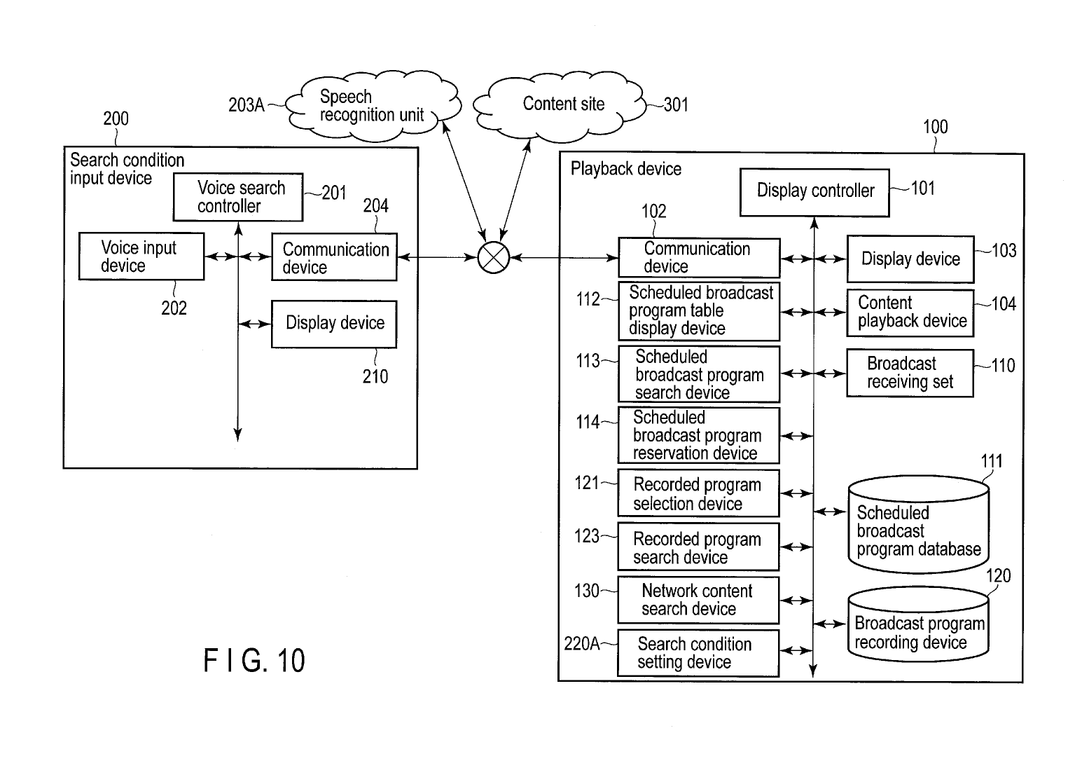

FIG. 10 illustrates the structure of the fifth embodiment. In FIG. 10, a voice recognition unit 203A which is the same in function as the voice recognition unit 203 is implemented as a site of the Internet, and a search condition setting device 220A which is the same in function as the search condition setting device 220 is arranged in the playback device 100. Therefore, the search condition input device 200 executes steps from the outset to the voice data capture in block B4, and the playback device 100 executes the rest of the steps from block B6 (voice recognition). Accordingly, the processing load imposed on the search condition input device 200 included in a portable device, such as a cellular phone, a smart phone, and a tablet computer, can be made light.

It should be noted that, when a search execution request is issued from the search condition input device 200 to the playback device 100 in block B14, the search condition is given in the first embodiment, but in the fifth embodiment, the voice data captured by the voice input device 202 is given. The display controller 101 of the playback device 100 obtains voice data from the search condition input device 200 using the communication device 102, and sends the voice data to the voice recognition unit 203A on the Internet once more using the communication device 102. The voice recognition unit 203A changes the voice data into character data. The search condition setting device 220A of the playback device 100 receives the character data from the voice recognition unit 203A, analyzes the syntax of the character data, extracts words, determines which item of a search condition each word corresponds to, and sets a search condition. The search condition setting device 220A instructs the display controller 101 to cause one of the scheduled broadcast program search device 113, the recorded program search device 123, and the network content search device 130 to operate according to one of the items in a search condition, i.e., a type of content. The above configuration also makes it possible to achieve the same operation as those achieved by the embodiments mentioned above.

A search condition is input by a microphone using speech recognition technology in each of the above embodiments. However, it is not confined to such an approach. A search condition may be input using a keyboard, for instance. In such a case, what is necessary is merely to assign the re-search button of the fourth embodiment to a specific key in a keyboard.

It should be noted that the operational procedures of each embodiment can be implemented by a computer program, which makes it possible to easily accomplish the same effects as each embodiment only to install the computer program in a computer through a computer readable medium storing the computer program and to cause the computer to execute the installed computer program.

Moreover, the present invention is not restricted to the above mentioned embodiments as they are, and any component may be modified without departing from the spirit of the invention when the present invention is put into practice. Moreover, various modifications of the invention can be made with combination of any suitable components currently disclosed in the above mentioned embodiments. For example, it is possible to delete some components from all the components illustrated in each of the embodiments. Furthermore, it is possible to combine various components suitably selected from the disclosed different embodiments. It is moreover possible to implement the second embodiment, the third embodiment or the fourth embodiment as a modification of the fifth embodiment.

What is claimed is:

1. An electronic device comprising:
a display device configured to display content;
a setting device configured to set a search condition; and
a hardware processor configured to determine a type of content according to a state of the display device and search content based on the search condition and the type of content.

2. The electronic device of claim 1, wherein the hardware processor is further configured to determine the type of content according to one of the content displayed by the display device and an application program executed by the display device.

3. The electronic device of claim 2, wherein the hardware processor is further configured to determine the type of content according to whether the display device displays a broadcast program, or reproduces a recorded program, or reproduces network content.

4. The electronic device of claim 2, wherein the hardware processor is further configured to determine the type of content according to whether the display device executes a scheduled broadcast program table application, or a scheduled broadcast program search application, or a scheduled broadcast program reservation application, or a recorded program selection application, or a recorded program search application, or a network content search application.

5. The electronic device of claim 1, wherein, if at least one new item of a search condition is set by the setting device and the at least one new item is not included in an already set search condition, a new search condition including the at least one new item is set.

6. The electronic device of claim 5, wherein a new search condition is set according to at least one item of the search condition set by the setting device when a result of search is displayed by the display device.

7. The electronic device of claim 1, wherein, if at least one new item of a search condition is set by the setting device and the at least one new item is included in an already set search condition, a new search condition wherein the at least one new item replaces at least one already set item included in the already set search condition.

8. The electronic device of claim 7, wherein a new search condition is set according to at least one item of the search condition set by the setting device when a result of search is displayed by the display device.

9. The electronic device of claim 1, wherein the setting device is further configured to set a type of content; and
the hardware processor is further configured to change a determined type of content to the type of content set by the setting device.

10. The electronic device of claim 1, wherein the setting device comprises a voice input device.

11. A method comprising:
displaying content by a display device;
setting a search condition;
determining a type of content according to a state of the display device; and
searching content based on the search condition and the type of content.

12. A non-transitory computer readable medium having a plurality of executable instructions stored thereon configured to cause one or more computers to perform processing, the processing comprising:
displaying content by a display device;
setting a search condition;
determining a type of content according to a state of the display device; and
searching content based on the search condition and the type of content.
